(19) United States
(12) Patent Application Publication
(10) Pub. No.: US 2016/0315564 A1
(43) Pub. Date: Oct. 27, 2016

(54) DRIVING DEVICE

(71) Applicant: Murata Manufacturing Co., Ltd., Nagaokakyo-shi (JP)

(72) Inventor: Kenichi Kotani, Nagaokakyo-shi (JP)

(21) Appl. No.: 15/200,360

(22) Filed: Jul. 1, 2016

Related U.S. Application Data
(63) Continuation of application No. PCT/JP2015/050134, filed on Jan. 6, 2015.

(30) Foreign Application Priority Data
Jan. 28, 2014 (JP) 2014-013214

(51) Int. Cl. H02N 10/00; B60S 1/56; F03G 7/06

(52) U.S. Cl. CPC H02N 10/00; F03G 7/065; B60S 1/566

(57) ABSTRACT

A rotary shaft supported by a housing so as to be capable of rotating in a forward rotation direction and a reverse rotation direction. A shape-memory alloy member having a wire-like shape urges, by thermally contracting, the rotary shaft by applying an external force in the forward rotation direction. A bias spring urges the rotary shaft by applying an external force in the reverse rotation direction. A wiper is displaced along with rotation of the rotary shaft. The shape-memory alloy member is arranged such that, when a thermal contraction force is divided into a first partial thermal contraction force in the forward rotation direction and a second partial thermal contraction force in a length direction of the rotary shaft, the first partial thermal contraction force is larger than the second partial thermal contraction force.

### CROSS-REFERENCE TO RELATED APPLICATIONS

The present application is a continuation of PCT/JP2015/050134 filed Jan. 6, 2015, which claims priority to Japanese Patent Application No. 2014-013214, filed Jan. 28, 2014, the entire contents of each of which are incorporated herein by reference.

### FIELD OF THE INVENTION

The present disclosure relates to driving devices, and more particularly to a driving device that is applied to a foreign-matter removal device, which removes foreign matters such as raindrops and dust, and that displaces an object by rotational operation of a rotary shaft.

### BACKGROUND

An example of this type of driving device is disclosed in Patent Document 1. According to this related art, a shape-memory alloy member that is included in a driving unit generates heat by itself by being energized and contracts at a temperature above its transformation temperature. In addition, the shape-memory alloy member is formed in a coil shape so as to increase an operating range of the shape-memory alloy member according to temperature changes. A first end portion of the shape-memory alloy member is fixed in place by a hook, and a second end portion of the shape-memory alloy member is connected to a wire. The direction in which the wire extends is changed by a pulley, and movement of the wire, whose extending direction has been changed, is propagated to a blade via a converter. As a result of rotation of the blade, waterdrops on a surface of a mirror are swept away.

Patent Document 1: Japanese Unexamined Patent Application Publication No. 62-64649.

However, since a force of the shape-memory alloy member, which has a coil shape, in a direction in which the shape-memory alloy member contracts is small, in order to apply a force that causes the blade to rotate, the force being larger than kinematic friction generated between the blade and the mirror, to the blade, the shape-memory alloy member needs to be formed so as to be thick. As a result, in the related art, there has been a problem of increased power consumption when energizing the shape-memory alloy member. In addition, in the related art, there has been a problem in that, since the structure of the converter that is used for determining the rotation angle of the blade is complex, a reduction in the size of the driving device and a reduction in the manufacturing costs cannot be achieved.

### SUMMARY OF THE INVENTION

Accordingly, it is a main object of the present disclosure to provide a driving device that is capable of stably displacing an object by using a simple structure.

A driving device according to the present disclosure includes a rotary member that is supported so as to be capable of rotating in a first direction and a second direction which indicate opposite directions around a reference axis, a shape-memory alloy member that has a wire-like shape and that urges, by thermally contracting, the rotary member by applying an external force in the first direction, an elastic or biasing member that urges the rotary member by applying an external force in the second direction, and an object that is displaced along with rotation of the rotary member. The shape-memory alloy member is arranged such that, when a thermal contraction force is divided into a first partial thermal contraction force in the first direction and a second partial thermal contraction force in a length direction of the reference axis, the first partial thermal contraction force is larger than the second partial thermal contraction force.

Preferably, the driving device further includes a restricting member that restricts rotation of the rotary member in the second direction such that an upper limit of a rotation angle of the rotary member is an angle corresponding to a maximum deformation amount by which transformation of the shape-memory alloy member can repeatedly occur.

Preferably, the driving device further includes a supply source that supplies power to the shape-memory alloy member.

According to an embodiment of the present invention, the supply source includes two power supply terminals each of which is connected to one of end portions of a wire member that is formed of the shape-memory alloy member, and the rotary member includes a projecting or latch portion to which the wire member formed of the shape-memory alloy member is attached at a position that is different from the end portions.

More preferably, the rotary member includes a rotary shaft that extends along the reference axis and whose diameter varies depending on a position in the length direction, and the latch portion projects in a radial direction of the rotary shaft from a portion of an outer peripheral surface of the rotary shaft, the portion being located at a position at which the diameter of the rotary shaft is different from a maximum diameter of the rotary shaft.

According to another embodiment of the present invention, the driving device further includes a measuring device that measures a resistance of the shape-memory alloy member and a control device that controls energization of the shape-memory alloy member by referencing to a resistance measured by the measuring device.

In this case, the control device controls the energization by detecting an inflection point, which appears in the resistance when the shape-memory alloy member is overloaded and performs a pre-operation check in preliminary driving at a temperature lower than a transformation temperature of the shape-memory alloy member or confirms, in preliminary driving at a temperature lower than a transformation temperature of the shape-memory alloy member, that the object is not in operation.

Preferably, the object includes a wiper that rotates in order to remove raindrops.

Preferably, the driving device further includes a changing portion that changes an extending direction of the wire member formed of the shape-memory alloy member at a position spaced apart from the rotary member.

Although a torque generated in the rotary member by thermal contraction of the shape-memory alloy member increases as a direction in which a thermal contraction force acts becomes closer to a direction perpendicular to the length direction of the reference axis, the shape-memory alloy member is arranged such that the first partial thermal contraction force in a circumferential direction of the reference axis is larger than the second partial thermal contraction force in the length direction of the reference axis.

As a result, a high torque can be obtained even if the line width of the shape-memory alloy member is small. In addition, by setting the line width of the shape-memory alloy member to be small, the response characteristic of the shape-memory alloy member with respect to energization and the displacement characteristic of the object are improved. As a result, the object can be stably displaced by using a simple structure.

The above-mentioned object, other objects, features, and advantages of the present disclosure will become more apparent from the following detailed descriptions of embodiments of the present disclosure, which refers to the drawings.

### BRIEF DESCRIPTION OF DRAWINGS

FIG. 1 is an exploded perspective view illustrating an example of a state of a raindrop removal device according to an embodiment of the present invention as seen from one direction.

FIG. 2 is an exploded perspective view illustrating an example of the state of the raindrop removal device illustrated in FIG. 1 as seen from another direction.

FIG. 3 is an exploded perspective view illustrating an example of the state of the raindrop removal device illustrated in FIG. 1 as seen from another direction.

FIG. 4 is an exploded perspective view illustrating another example of a state of a housing of the raindrop removal device illustrated in FIG. 1 as seen from one direction.

FIG. 5 is an exploded perspective view illustrating an example of a state of a raindrop removal device according to another embodiment as seen from one direction.

FIG. 6 is an exploded perspective view illustrating an example of a state of a raindrop removal device according to another embodiment as seen from one direction.

FIG. 7 is an exploded perspective view illustrating an example of a state of a raindrop removal device according to another embodiment as seen from one direction.

FIG. 8 is an exploded perspective view illustrating an example of a state of a raindrop removal device according to another embodiment as seen from one direction.

FIG. 9 is a perspective view illustrating an example of a state of a raindrop removal device according to another embodiment as seen from one direction.

FIG. 10 is a perspective view illustrating another example of the state of the raindrop removal device illustrated in FIG. 9 as seen from one direction.

FIG. 11 is an exploded perspective view illustrating an example of a state of a raindrop removal device according to another embodiment as seen from one direction.

FIG. 12 is a perspective view illustrating an example of the state of the raindrop removal device illustrated in FIG. 11 as seen from another direction.

FIG. 13 is a block diagram illustrating an example of the configuration of a control device that controls energization of a shape-memory alloy member.

FIGS. 14 and 15 illustrate a flowchart for a method of the operation of a control circuit according to an exemplary embodiment.

FIG. 16 is a graph representing an exemplary relationship between a contraction amount and a resistance of the shape-memory alloy member.

FIG. 17 is a perspective view illustrating an example of a state of a rear camera and an example of a state of a raindrop removal device according to the present invention as seen from one direction.

FIG. 18 is a perspective view illustrating an example of a state of a rear camera and an example of a state of another raindrop removal device according to the present invention as seen from one direction.

FIG. 19 is a diagram illustrating an example of the raindrop removal device illustrated in FIG. 17. FIG. 19 (a) is a front view of the raindrop removal device. FIG. 19 (b) is a cross-sectional view taken along line A-A of FIG. 19 (a). FIG. 19 (c) is a detailed view of a portion B illustrated in FIG. 19 (b). FIG. 19 (d) is a perspective view of the raindrop removal device in a state where a housing has been removed.

FIG. 20 is a perspective view illustrating an example of a state of a rear camera and an example of a state of another raindrop removal device according to the present invention as seen from one direction.

### DETAILED DESCRIPTION OF EXEMPLARY EMBODIMENTS

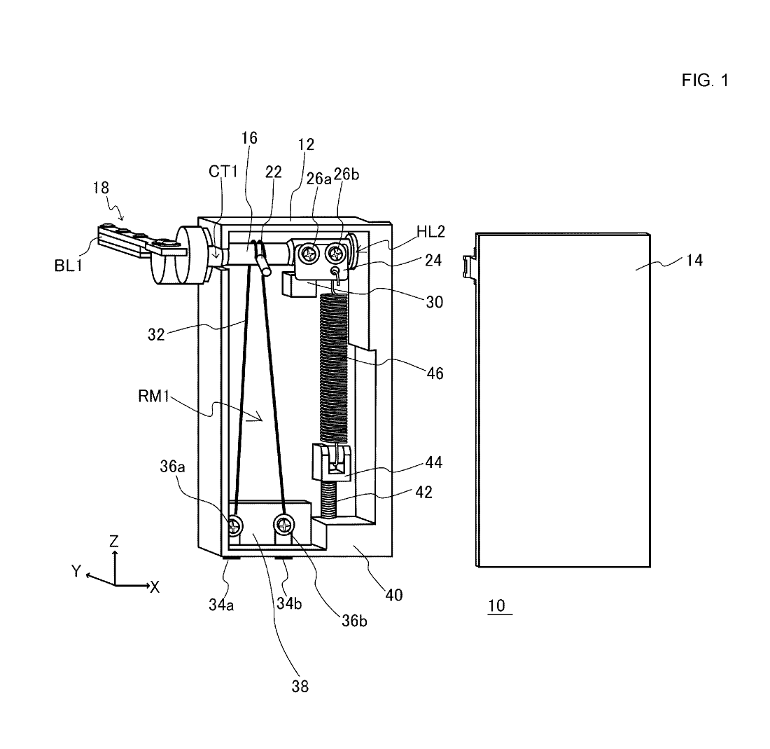

Referring to FIG. 1 to FIG. 3, a raindrop removal device 10 according to an embodiment of the present invention is a device that is used for removing raindrops deposited on, for example, a lens of a rear camera that is mounted on a rear portion of an automobile, and the raindrop removal device 10 includes a housing 12 that has a rectangular parallelepiped shape and that includes an accommodating chamber RM1. An X-axis is used to indicate the width direction of the housing 12, a Y-axis is used to indicate the thickness direction of the housing 12, and a Z-axis is used to indicate the height direction of the housing 12. In this case, the accommodating chamber RM1 is open in a negative Y-axis direction. A lid 14 is formed in a plate-like shape and has a main surface having the same size as that of a main surface of the housing 12. When the lid 14 is placed on the housing 12 from the negative Y-axis direction in a position in which side surfaces of the lid 14 are flush with corresponding side surfaces of the housing 12, the accommodating chamber RM1 is hermetically sealed by the housing 12.

Note that, in both the housing 12 and the lid 14, the side surface that is oriented in a positive X-axis direction is defined as “a positive X-axis side surface”, the side surface that is oriented in a negative X-axis direction is defined as “a negative X-axis side surface”, the side surface that is oriented in a positive Z-axis direction is defined as “a positive Z-axis side surface”, and the side surface that is oriented in a negative Z-axis direction is defined as “a negative Z-axis side surface”.

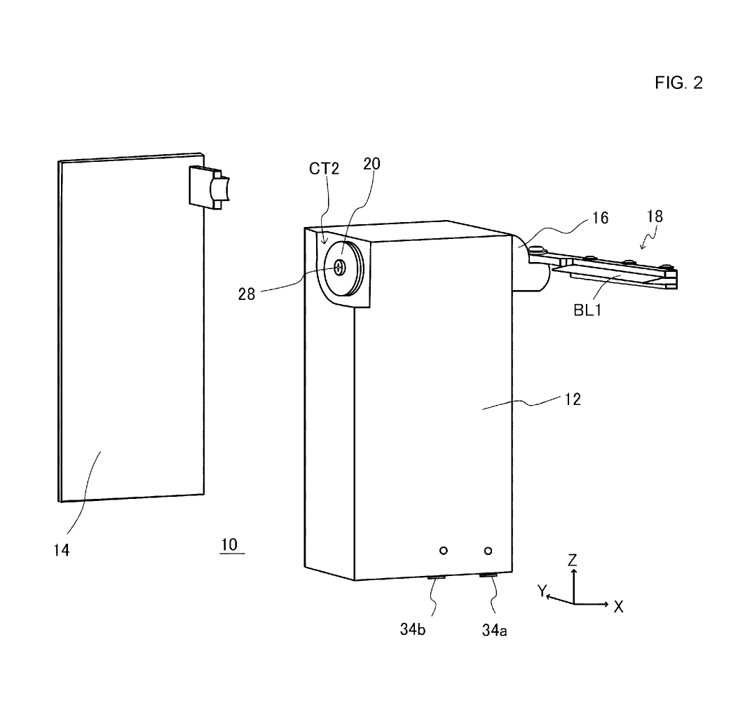

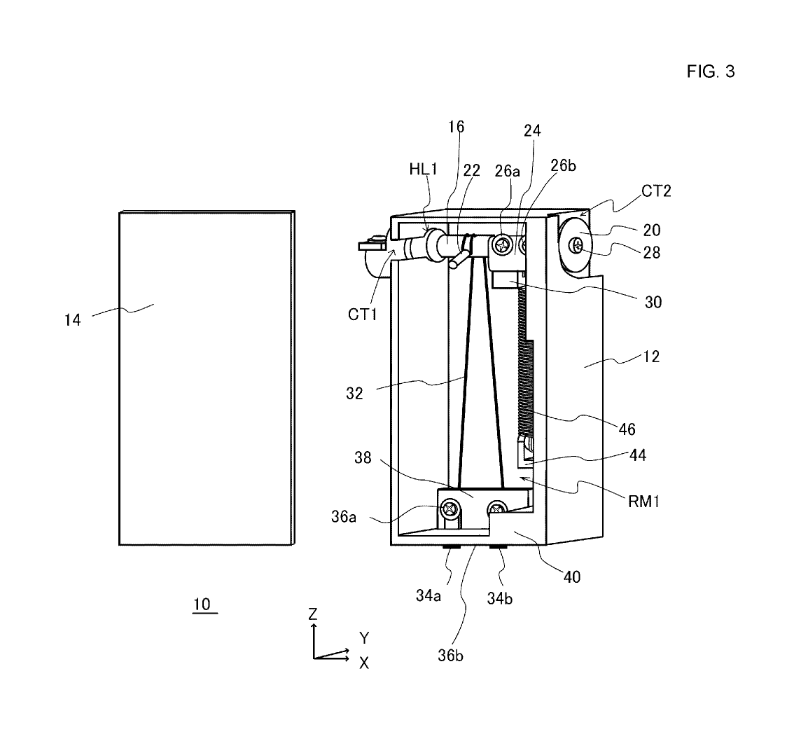

Two through holes HL1 and HL2 each extending in the X-axis direction of the same YZ coordinate system are respectively formed in the negative X-axis side surface and the positive X-axis side surface of the housing 12 (see FIG. 3 for the through hole HL1 and see FIG. 1 for the through hole HL2). A cutout portion CT1 is formed in a wall that isolates the negative X-axis side surface and the accommodating chamber RM1 from each other, the cutout portion CT1 extending from a top surface (i.e., a surface that is oriented in the negative Y-axis direction) of the wall to the through hole HL1 (see particularly FIG. 1 and FIG. 3). A cutout portion CT2 that cuts out part of the entire length of the through hole HL2 is formed in the positive X-axis side surface of the housing 12 so as to form a flat surface that is perpendicular to the X-axis (see particularly FIG. 2 and FIG. 3).

A rotary shaft 16 has a length larger than the width of the housing 12 and is mounted in the housing 12. A first end portion of the rotary shaft 16 projects outside the housing 12 via the through hole HL1, and a second end portion of the rotary shaft 16 projects outside the housing 12 via the through hole HL2. The outer diameter of the rotary shaft 16 is substantially equal to the inner diameter of the through hole HL1 at a position at which the rotary shaft 16 is in contact with the through hole HL1 and is substantially equal to the inner diameter of the through hole HL2 at a position at which the rotary shaft 16 is in contact with the through hole HL2. Grease retaining grooves (not illustrated) for reducing friction that will be generated between the rotary shaft 16 and the inner peripheral surfaces of the through holes HL1 and HL2 and for preventing water and the like from entering are formed in the inner peripheral surfaces of the through holes HL1 and HL2.

The diameter of the first end portion of the rotary shaft 16 is increased, and this large diameter portion has a flat surface that is formed so as to be oriented in the positive X-axis direction and so as to be in contact with the negative X-axis side surface of the housing 12 (see particularly FIG. 1 and FIG. 3). A plate member 20 that has a circular plate-like shape and an outer diameter larger than the inner diameter of the through hole HL2 is attached to the second end portion of the rotary shaft 16 by a screw 28 (see particularly FIG. 2 and FIG. 3). A main surface of the plate member 20 is oriented in the negative X-axis direction and is in contact with the flat surface, which forms the cutout portion CT2.

A plate-shaped wiper 18 extending in a radial direction of the rotary shaft 16 is attached to the first end portion of the rotary shaft 16 (see particularly FIG. 1 and FIG. 2). A blade BL1 that is made of rubber is sandwiched by the wiper 18 and extends in the radial direction of the rotary shaft 16. The blade BL1 slides on a surface of a lens (not illustrated). The angles of the wiper 18 and the blade BL1 change along with rotation of the rotary shaft 16, and raindrops deposited on a lens cover are removed by the blade BL1.

The outer diameter of the rotary shaft 16 is decreased in a portion of the rotary shaft 16, the portion being accommodated in the accommodating chamber RM1 and forming part of the length of the rotary shaft 16. A projecting portion 22 projecting from an outer peripheral surface of the rotary shaft 16 in the radial direction is formed in the portion of the rotary shaft 16, in which the outer diameter of the rotary shaft 16 is decreased. In addition, the outer diameter of the rotary shaft 16 is slightly increased in another portion of the rotary shaft 16, the other portion being accommodated in the accommodating chamber RM1 and forming another part of the length of the rotary shaft 16. A plate-shaped hook 24 is attached to the other portion of the rotary shaft 16, in which the outer diameter of the rotary shaft 16 is slightly increased, by screws 26a and 26b.

On a bottom surface (i.e., a surface that is oriented in the negative Y-axis direction) of the accommodating chamber RM1, a rotation stopper 30 is formed at a position that is superposed with the hook 24 as seen from the negative Y-axis direction (see particularly FIG. 1 and FIG. 3). Accordingly, when the rotary shaft 16 is forced to rotate in a counterclockwise direction (i.e., reverse rotation direction) as seen from the positive X-axis direction, the hook 24 is brought into contact with the rotation stopper 30, and further rotation of the rotary shaft 16 is restricted. Note that the upper limit of the angle by which the rotary shaft 16 can rotate in the reverse rotation direction is an angle corresponding to a maximum deformation amount by which transformation of a shape-memory alloy member 32, which will be described below, can repeatedly occur.

On the bottom surface of the accommodating chamber RM1, a base portion 38 is formed, integrally with the housing 12, in the vicinity of a wall that isolates the negative Z-axis side surface and the accommodating chamber RM1 from each other. The base portion 38 supports power supply terminals 34a and 34b each extending to the accommodating chamber RM1 through the wall. The shape-memory alloy member 32 is formed in a wire-like shape. A first end portion of the shape-memory alloy member 32 is connected to the power supply terminal 34a by a screw 36a, and a second end portion of the shape-memory alloy member 32 is connected to the power supply terminal 34b by a screw 36b. An entire length portion of the shape-memory alloy member 32 is bent in the negative Y-axis direction at a position further toward the positive-Z-axis direction side than the rotary shaft 16 after passing through a space between the rotary shaft 16 and the bottom surface of the accommodating chamber RM1 and is hooked on the projecting portion 22. A center portion of the shape-memory alloy member 32, which is hooked, in a length direction of the shape-memory alloy member 32 forms a substantially U shape in the vicinity of the projecting portion 22.

When power is supplied to the shape-memory alloy member 32 by the power supply terminals 34a and 34b, the shape-memory alloy member 32 contracts by being heated. The rotary shaft 16 is urged by an external force in a clockwise direction (i.e., forward rotation direction) as seen from the positive X-axis direction. Since the shape-memory alloy member 32 is arranged in the above-described manner, when a thermal contraction force is divided into a first partial thermal contraction force in the forward rotation direction and a second partial thermal contraction force in a length direction of the rotary shaft 16, the first partial thermal contraction force is larger than the second partial thermal contraction force. As a result, a high torque is generated in the rotary shaft 16 in the forward rotation direction.

Characteristics of the shape-memory alloy member 32 will now be briefly described. At the transformation temperature of the shape-memory alloy member 32 or lower, bonds of atoms forming the crystal lattice of the shape-memory alloy member 32 will not be broken, and only lattice deformation occurs. Consequently, when a load that will not break the bonds of the atoms is applied to the shape-memory alloy member 32 in the length direction of the shape-memory alloy member 32 at the transformation temperature or lower, about 6% deformation occurs in the shape-memory alloy 32 as a result of lattice deformation, and the shape-memory alloy member 32 expands. When the shape-memory alloy member 32 is heated to a temperature above the transformation temperature, the shape-memory alloy member 32 returns to its original shape before the lattice deformation occurs, and the length of the shape-memory alloy member 32 is reduced.

Note that the contraction amount of the shape-memory alloy member 32 is about 6%, which is small. Considering this, the outer diameter of the rotary shaft 16 is decreased at a position at which the projecting portion 22 is formed. As a result, a large rotation angle can be obtained even though the contraction amount is small.

A base portion 40 is formed integrally with the housing 12 at a position further toward the positive-X-axis direction side than the base portion 38. The base portion 40 supports an adjustment screw 42 to which a hook 44 is screwed. The adjustment screw 42 extends along the Z-axis, and fine adjustment of the position of the hook 44 in the Z-axis direction is performed by rotating the hook 44 about the Z-axis. A first end portion of a bias spring (a coil-shaped tension spring) 46 is latched to the hook 24, and a second end portion of the bias spring 46 is latched to the hook 44. The bias spring 46 causes the rotary shaft 16 to be urged by an external force in the reverse rotation direction.

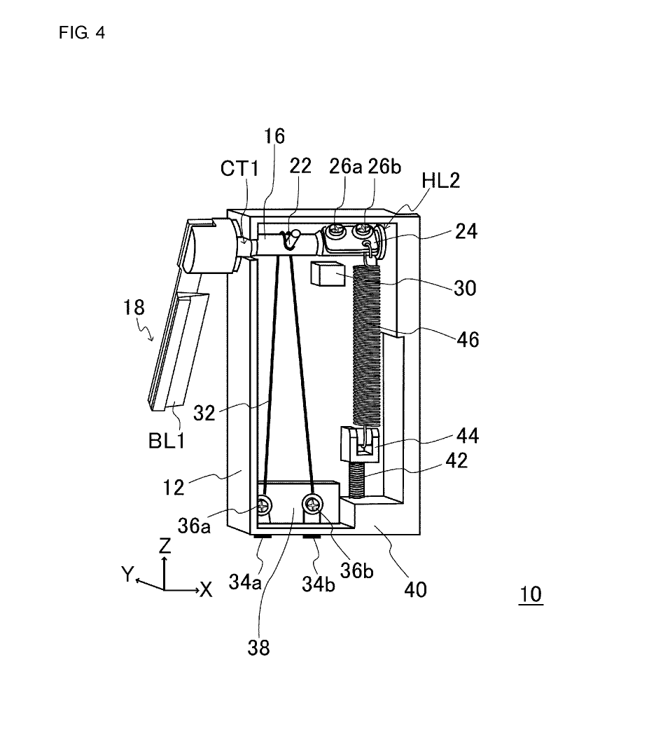

Thus, the wiper 18, which is attached to the rotary shaft 16, rotates in a forward direction when the shape-memory alloy member 32 is energized, and the wiper 18 rotates in a reverse direction when energization of the shape-memory alloy member 32 is stopped. In other words, the wiper 18 moves to a position illustrated in FIG. 4 upon energization and returns to a position illustrated in FIG. 1 when energization is stopped.

To be more specific, before the shape-memory alloy member 32 is energized, lattice deformation occurs in the shape-memory alloy member 32 at the transformation temperature or lower, and the shape-memory alloy member 32 is forced to deform and expand by the bias spring 46. Once the shape-memory alloy member 32 has been energized, the shape-memory alloy member 32 generates heat by itself due to Joule heat, and when the temperature of the shape-memory alloy member 32 exceeds the transformation temperature, the shape-memory alloy member 32 returns to its original shape before the lattice deformation occurs. Thermal contraction occurs in the shape-memory alloy member 32, and this causes the rotary shaft 16 to rotate in the forward direction while the bias spring 46 is forced to expand. The blade BL1, which is attached to the wiper 18, rotates in the forward direction as a result of the rotary shaft 16 rotating in the forward direction.

During the period when the shape-memory alloy member 32 is energized, the resistance of the shape-memory alloy member 32 is monitored. The energization is stopped when the resistance, which has been monitored, falls below a predetermined value. Here, the predetermined value is set from the standpoint of a necessary rotation angle of the blade BL1, the standpoint of preventing the shape-memory alloy member 32 from being excessively deformed, and the like.

After the energization has been stopped, the shape-memory alloy member 32 is naturally cooled. When the temperature of the shape-memory alloy member 32 falls below the transformation temperature, lattice deformation occurs. The shape-memory alloy member 32 expands, and the rotary shaft 16 rotates in the reverse direction while being pulled by the bias spring 46. The blade BL1 rotates in the reverse direction as a result of the rotary shaft 16 rotating in the reverse direction.

Note that the shape memory alloy member 32 is made of an alloy containing Ni/Ti and the like. The rotary shaft 16 and the wiper 18 are made of a metal such as aluminum and a resin such as polyphenylene sulfide (PPS). The bias spring 46 is made of a spring material made of stainless steel or the like, and the housing 12 and the lid 14 are made of a resin such as PPS. The power supply terminals 34a and 34b are made of a conductor made of copper, a brass, or the like.

As described above, according to the present embodiment, the rotary shaft 16 is supported by the housing 12 so as to be capable of rotating in the forward rotation direction and the reverse rotation direction. The shape-memory alloy member 32 having a wire-like shape urges, by thermally contracting, the rotary shaft 16 by applying an external force in the forward rotation direction. The bias spring 46 urges the rotary shaft 16 by applying an external force in the reverse rotation direction. The wiper 18 is displaced along with rotation of the rotary shaft 16. Here, the shape-memory alloy member 32 is arranged such that, when the thermal contraction force is divided into the first partial thermal contraction force in the forward rotation direction and the second partial thermal contraction force in the length direction of the rotary shaft 16, the first partial thermal contraction force is larger than the second partial thermal contraction force.

Although a torque generated in the rotary shaft 16 by thermal contraction of the shape-memory alloy member 32 increases as a direction in which the thermal contraction force acts becomes closer to a direction perpendicular to the length direction of the rotary shaft 16, the shape-memory alloy member 32 is arranged such that the first partial thermal contraction force in the forward rotation direction is larger than the second partial thermal contraction force in the length direction of the rotary shaft 16.

As a result, a high torque can be obtained even if the line width of the shape-memory alloy member 32 is small. In addition, by setting the line width of the shape-memory alloy member 32 to be small, the response characteristic of the shape-memory alloy member 32 with respect to energization and the displacement characteristic of the wiper 18 are improved. As a result, the wiper 18 can be stably displaced by using a simple structure.

In addition, in the present embodiment, the rotation stopper 30 restricts rotation of the shape-memory alloy member 32 in the reverse rotation direction such that the upper limit of the rotation angle of the rotary shaft 16 is the angle corresponding to the maximum deformation amount by which transformation of the shape-memory alloy member 32 can repeatedly occur. Thus, even if an unexpected external force that causes the wiper 18 to rotate in the reverse direction is urged, rotation of the rotary shaft 16 in the reverse direction is restricted by the rotation stopper 30. As a result, the shape-memory alloy member 32 can be prevented from sustaining damage due to the application of an unexpected external force.

Note that, although a coil-shaped tension spring is employed as the bias spring 46 in the present embodiment, an elastic member such as a pressing spring may be employed as long as an external force in the reverse rotation direction can be urged to the rotary shaft 16.

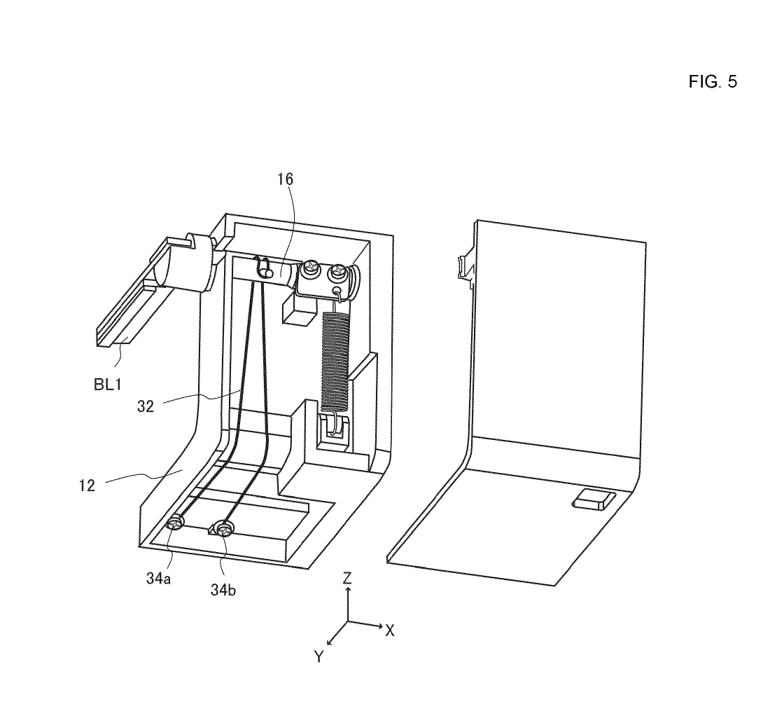

In addition, although the housing 12 is formed in a rectangular parallelepiped shape in the present embodiment, the housing 12 may be formed so as to have an L shape as seen from the positive X-axis direction. In this case, the raindrop removal device 10 has the structure illustrated in FIG. 5. According to FIG. 5, a portion of the housing 12 located on the negative-Z-axis direction side is bent in an arc-like manner in the positive Y-axis direction.

As a result, the shape-memory alloy member 32 can be compactly disposed, and in addition, the rotation angle of the blade BL1 can be increased.

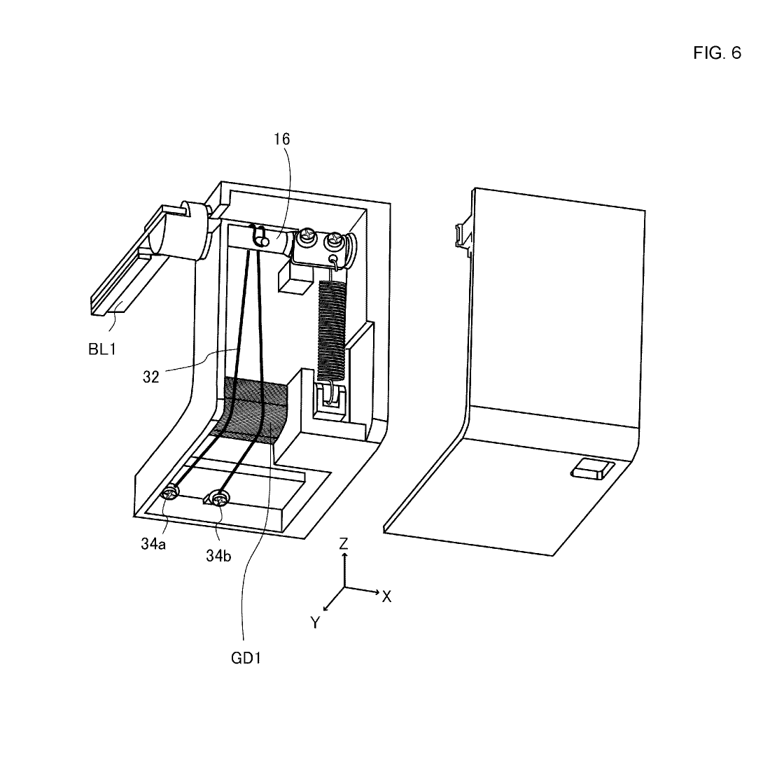

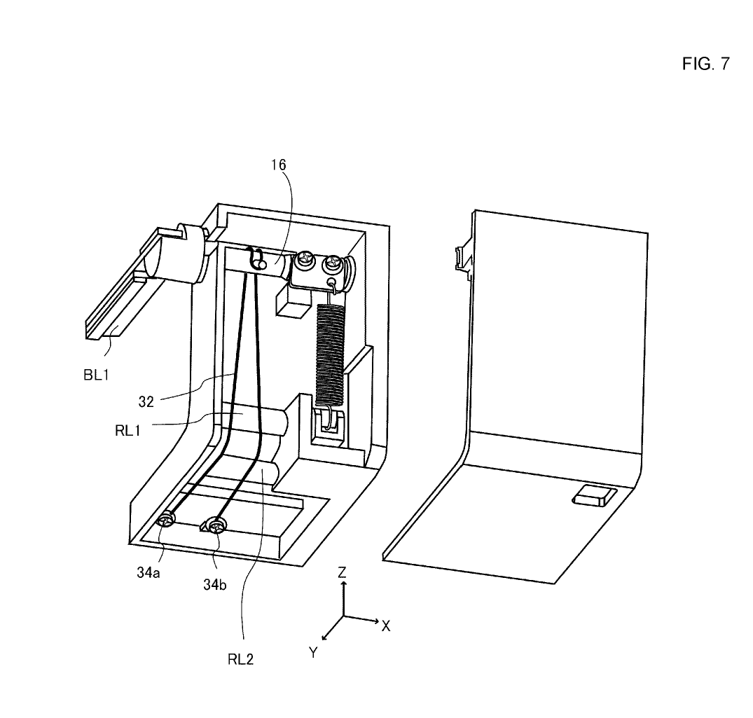

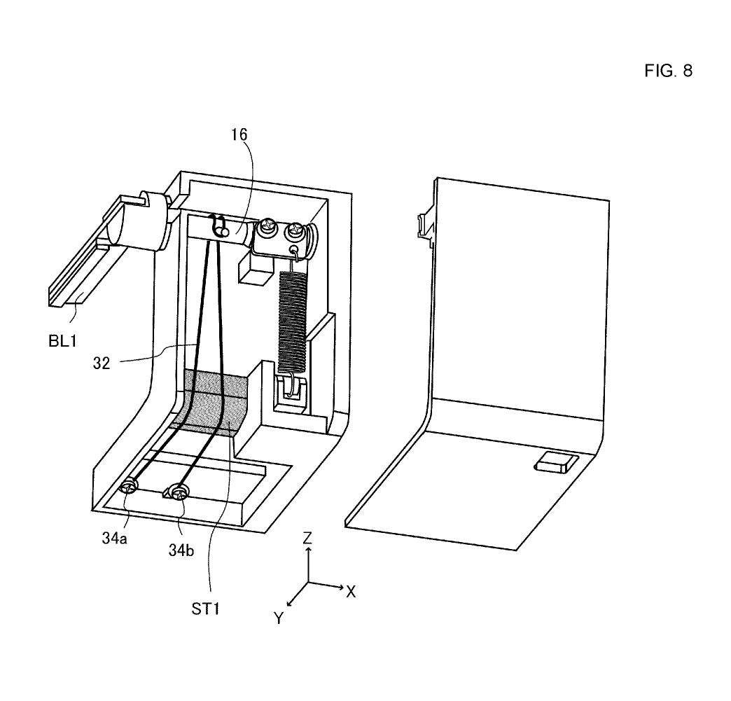

In addition, given the fact that, when the housing 12 has an L shape, the shape-memory alloy member 32 is brought into contact with a bottom surface of the housing 12 in a bent portion (relay portion), a stationary guide GD1 that is made of a metal such as aluminum or a resin such as Teflon® may be disposed on the bent portion (see FIG. 6). Alternatively, cylindrical rollers RL1 and RL2 that are made of a metal such as aluminum or a resin such as Teflon and that rotate about the X-axis may be disposed on the bent portion (see FIG. 7). Alternatively, a thin sheet ST1 that is made of a resin such as Teflon may be interposed between the bent portion and the shape-memory alloy member 32 so as to improve slidability (see FIG. 8).

This can reduce kinematic friction that is generated in the bent portion of the housing 12 when the shape-memory alloy member 32 contracts. Note that such kinematic friction can be further reduced by applying grease or the like to a surface of the stationary guide GD1, surfaces of the rollers RL1 and RL2, or a surface of the sheet ST1.

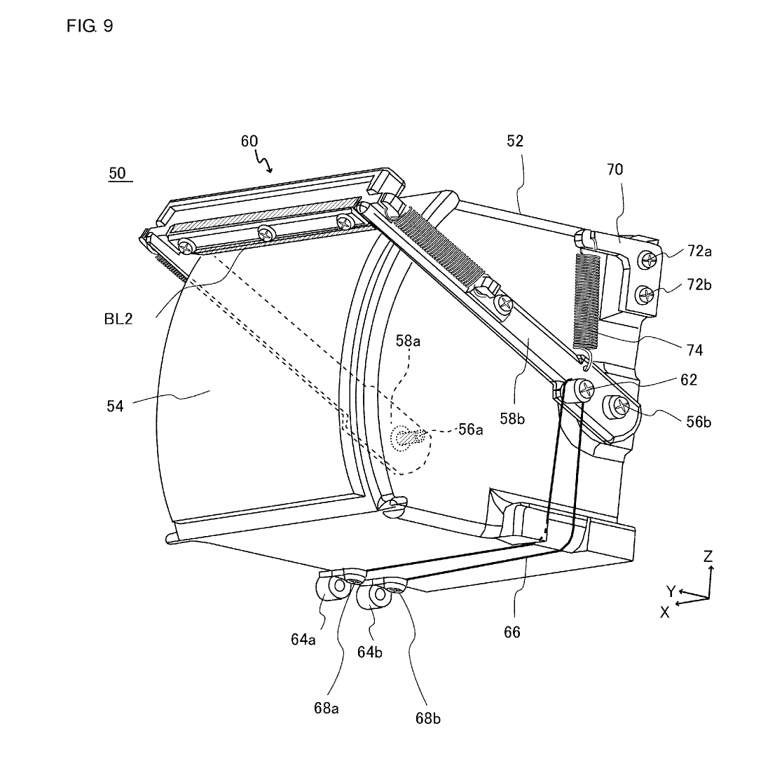

Referring to FIG. 9, a raindrop removal device 50 according to another embodiment includes a housing 52 in which a rear camera is accommodated. An X-axis is used to indicate a width direction of the housing 52, a Y-axis is used to indicate a length direction of the housing 52, and a Z-axis is used to indicate the height direction of the housing 52. In this case, a front surface (i.e., a surface that is oriented in the positive Y-axis direction) of the housing 52 and a rear surface (i.e., a surface that is oriented in the negative Y-axis direction) of the housing 52 are open. However, the front surface of the housing 52 is covered with a transparent cover glass 54 that bulges toward the positive Y-axis direction in an arc-like manner.

A screw 56a is screwed to a first side surface (i.e., a side surface that is oriented in the positive X-axis direction) of the housing 52 in the negative X-axis direction. The first side surface will hereinafter be defined as a positive X-axis side surface. A screw 56b is screwed to a second side surface (i.e., a side surface that is oriented in the negative X-axis direction) of the housing 52 in the positive X-axis direction. The second side surface will hereinafter be defined as negative X-axis side surface. Note that a YZ coordinate system that shows the positions at which the screws 56a and 56b are screwed to the first and second side surfaces is common to the screws 56a and 56b.

A base end portion of an arm 58a is attached to the positive X-axis side surface of the housing 52 by the screw 56a, and a base end portion of an arm 58b is attached to the negative X-axis side surface of the housing 52 by the screw 56b. In other words, the arm 58a is supported so as to be capable of rotating about the axis of the screw 56a, and the arm 58b is supported so as to be capable of rotating about the axis of the screw 56b.

The arms 58a and 58b have the same length, and a wiper 60 is clamped between the tip end portions of the arms 58a and 58b. In other words, the wiper 60 has a length substantially the same as the width of the housing 52. A first end portion of the wiper 60 is supported by the tip end portion of the arm 58a, and a second end portion of the wiper 60 is supported by the tip end portion of the arm 58b. A blade BL2 that is made of rubber is sandwiched by the wiper 60 and extends in the X-axis direction. The blade BL2 slides on a surface of the cover glass 54. Raindrops deposited on the cover glass 54 are removed by the blade BL2.

A projecting portion 62 projecting in the negative X-axis direction is provided in the vicinity of the base end portion of the arm 58b. Two power supply terminals 64a and 64b are disposed so as to be arranged next to each other in the Y-axis direction on an end portion of a bottom surface of the housing 52, the end portion being located on the positive-X-axis-direction side. A first end portion of a shape-memory alloy member 66 having a wire-like shape is connected to the power supply terminal 64a by a screw 68a, and a second end portion of the shape-memory alloy member 66 is connected to the power supply terminal 64b by a screw 68b.

An entire length portion of the shape-memory alloy member 66 is bent in the positive Z-axis direction in an end portion of the bottom surface of the housing 52, the end portion being located on the negative-X-axis-direction side, and is hooked on the projecting portion 62. A center portion of the shape-memory alloy member 66, which is hooked, in a length direction of the shape-memory alloy member 66 forms a substantially inverted U shape in the vicinity of the projecting portion 62.

When power is supplied to the shape-memory alloy member 66 by the power supply terminals 64a and 64b, the shape-memory alloy member 66 contracts by being heated. The arms 58a and 58b and the wiper 60 are urged by an external force in the clockwise direction (i.e., forward rotation direction) as seen from the positive X-axis direction. Since the shape-memory alloy member 66 is arranged in the above-described manner, when a thermal contraction force is divided into a first partial thermal contraction force in the forward rotation direction and a second partial thermal contraction force in the Y-axis direction, the first partial thermal contraction force is larger than the second partial thermal contraction force.

Note that, as described above, the contraction amount of the shape-memory alloy member 66 is about 6%, which is small. Considering this, the projecting portion 62 is disposed in the vicinity of the screw 56b so as to be positioned as close as possible to the screw 56b. As a result, a large rotation angle can be obtained even though the contraction amount is small.

A spring post 70 is attached, by screws 72a and 72b, to the negative X-axis side surface of the housing 52 at a position that corresponds to a first end portion of the negative X-axis side surface that is located on the positive-Z-axis-direction side and a second end portion of the negative X-axis side surface that is located on the negative-Y-axis-direction side. A first end portion of a bias spring 74 is latched to the spring post 70, and a second end portion of the bias spring 74 is latched to the arm 58b. The bias spring 74 urges the arms 58a and 58b and the wiper 60 by applying an external force in the counterclockwise direction (i.e., reverse rotation direction) as seen from the positive X-axis direction.

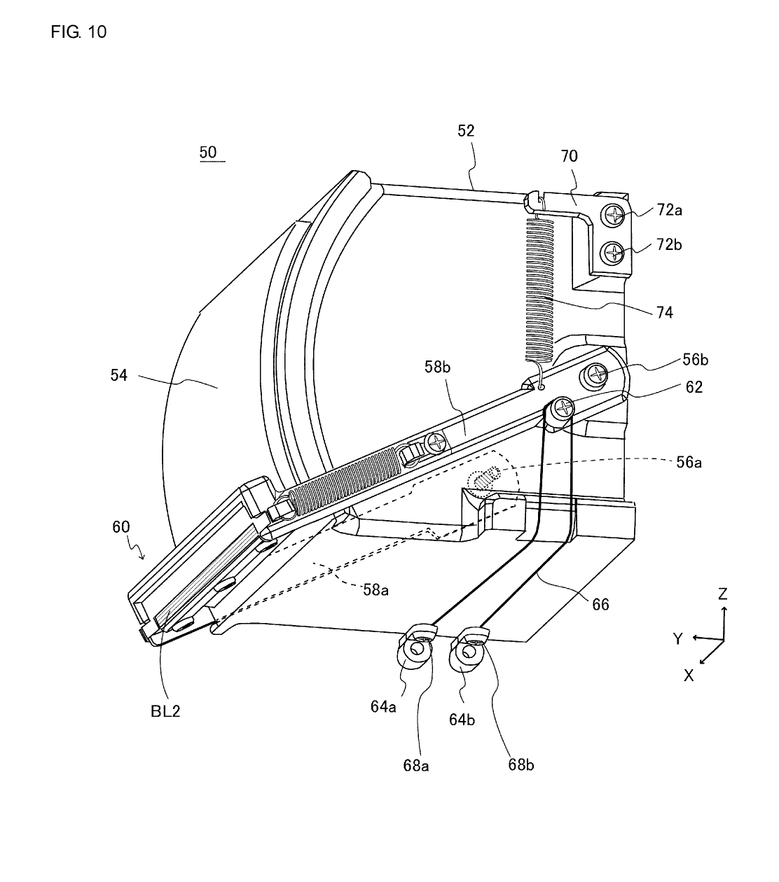

Thus, the blade BL2, which is sandwiched by the wiper 60, slides on the surface of the cover glass 54 in the forward direction when the shape-memory alloy member 66 is energized and slides on the surface of the cover glass 54 in the reverse direction when energization of the shape-memory alloy member 66 is stopped. In other words, the blade BL2 moves to a position illustrated in FIG. 10 upon energization and returns to a position illustrated in FIG. 9 when the energization is stopped.

To be more specific, before the shape-memory alloy member 66 is energized, lattice deformation occurs in the shape-memory alloy member 66 at the transformation temperature of the shape-memory alloy member 66 or lower, and the shape-memory alloy member 66 is forced to deform and expand by the bias spring 74. Once the shape-memory alloy member 66 has been energized, the shape-memory alloy member 66 generates heat by itself due to Joule heat, and when the temperature of the shape-memory alloy member 66 exceeds the transformation temperature, the shape-memory alloy member 66 returns to its original shape before the lattice deformation occurs. Thermal contraction occurs in the shape-memory alloy member 66, and this causes the blade BL2 to rotate in the forward direction while the bias spring 74 is forced to expand.

During the period when the shape-memory alloy member 66 is energized, the resistance of the shape-memory alloy member 66 is monitored. The energization is stopped when the resistance, which has been monitored, falls below a predetermined value. Here, the predetermined value is set from the standpoint of a necessary rotation angle of the blade BL2, the standpoint of preventing the shape-memory alloy member 66 from being excessively deformed, and the like.

After the energization has been stopped, the shape-memory alloy member 66 is naturally cooled. When the temperature of the shape-memory alloy member 66 falls below the transformation temperature, lattice deformation occurs. The shape-memory alloy member 66 expands, and the blade BL2 rotates in the reverse direction while being pulled by the bias spring 74.

Note that the shape memory alloy member 66 is made of an alloy containing Ni/Ti and the like. The housing 52 is made of a resin such as polyphenylene sulfide (PPS), and the cover glass 54 is made of a transparent resin such as polycarbonate. The bias spring 76 is made of a spring material made of stainless steel or the like, and the power supply terminals 64a and 64b are made of a conductor made of copper, a brass, or the like.

As described above, according to the present embodiment, the arm 58a is supported by the housing 52 so as to be capable of rotating about the axis of the screw 56a, and the arm 58b is supported by the housing 52 so as to be capable of rotating about the axis of the screw 56b. The shape-memory alloy member 66 having a wire-like shape urges, by thermally contracting, the arms 58a and 58b by applying an external force in the forward rotation direction. The bias spring 74 urges the arms 58a and 58b by applying an external force in the reverse rotation direction. The wiper 60 slides on the surface of the cover glass 54 along with rotation of the arms 58a and 58b. Here, the shape-memory alloy member 66 is arranged such that, when the thermal contraction force is divided into the first partial thermal contraction force in the forward rotation direction and the second partial thermal contraction force in the Y-axis direction, the first partial thermal contraction force is larger than the second partial thermal contraction force.

Although a torque generated in the arms 58a and 58b by thermal contraction of the shape-memory alloy member 66 increases as a direction in which the thermal contraction force acts becomes closer to a direction perpendicular to the Y-axis direction, the shape-memory alloy member 66 is arranged such that the first partial thermal contraction force in the forward rotation direction is larger than the second partial thermal contraction force in the Y-axis direction.

As a result, a high torque can be obtained even if the line width of the shape-memory alloy member 66 is small. In addition, by setting the line width of the shape-memory alloy member 66 to be small, the response characteristic of the shape-memory alloy member 66 with respect to energization and the displacement characteristic of the wiper 60 are improved. As a result, the wiper 60 can be stably displaced by using a simple structure. In addition, in the present embodiment, it is only necessary to cover the rear camera with the housing 52, and thus, the degree of freedom when designing the housing 52 increases.

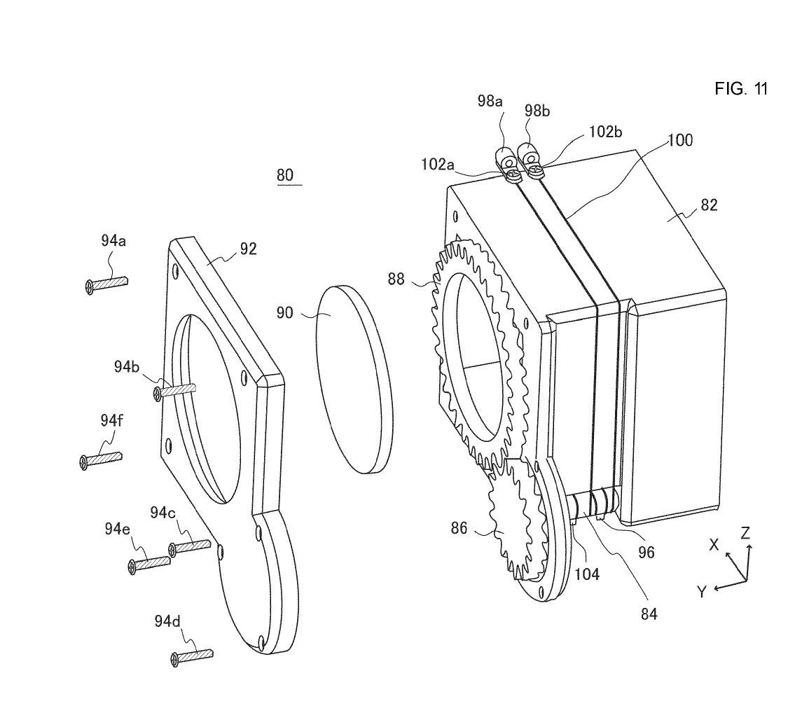

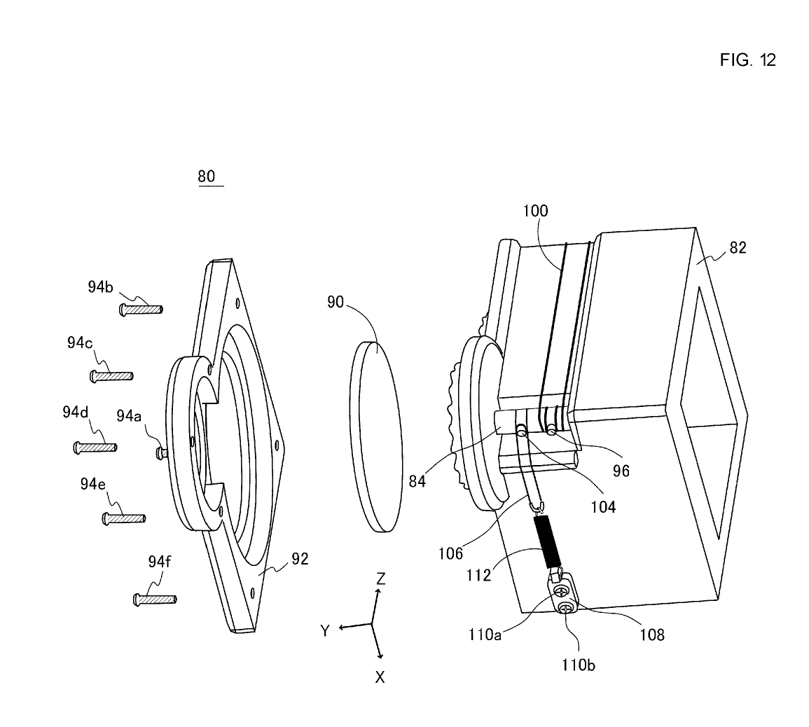

Referring to FIG. 11 and FIG. 12, a raindrop removal device 80 according to another embodiment includes a housing 82 in which a rear camera is accommodated. An X-axis is used to indicate a width direction of the housing 82, a Y-axis is used to indicate a length direction of the housing 82, and a Z-axis is used to indicate the height direction of the housing 82. In this case, a front surface (i.e., a surface that is oriented in the positive Y-axis direction) of the housing 82 and a rear surface (i.e., a surface that is oriented in the negative Y-axis direction) of the housing 82 are partially open.

A cover-glass rotary gear 86 and a cover-glass mounting gear 88 are attached to the front surface of the housing 82. The cover-glass rotary gear 86 is formed in a mushroom-like shape, and a plurality of teeth are formed on an outer peripheral surface of a portion of the cover-glass rotary gear 86, the portion corresponding to the pileus of the mushroom-like shape. A rotary shaft 84 that is included in the cover-glass rotary gear 86 extends in the negative Y-axis direction. The cover-glass mounting gear 88 is formed in a doughnut shape in order to hold a cover glass 90 having a circular plate-like shape, and a plurality of teeth are formed on an outer peripheral surface of the cover-glass mounting gear 88.

The plurality of teeth, which are included in the cover-glass rotary gear 86, engage with the plurality of teeth, which are included in the cover-glass mounting gear 88. Thus, when the rotary shaft 84 rotates in the clockwise direction (i.e., forward rotation direction) as seen from the negative Y-axis direction, the cover glass 90 rotates in the counterclockwise direction (i.e., reverse rotation direction) as seen from the negative Y-axis direction. When the rotary shaft 84 rotates in the reverse rotation direction, the cover glass 90 rotates in the forward rotation direction.

Note that the cover-glass rotary gear 86 and the cover-glass mounting gear 88 are covered with a lid 92, and a portion of the lid 92 at a position corresponding to the position of the cover glass 90 is open. The lid 92 is fixed to the housing 82 by screws 94a to 94f.

A projecting portion 96 projecting in a radial direction of the rotary shaft 84 is formed on an outer peripheral surface of the rotary shaft 84, which is included in the cover-glass rotary gear 86. Two power supply terminals 98a and 98b are disposed so as to be arranged next to each other in the Y-axis direction on an end portion of a top surface (i.e., a surface that is oriented in the positive Z-axis direction) of the housing 82, the end portion being located on the positive-X-axis-direction side. A first end portion of a shape-memory alloy member 100 having a wire-like shape is connected to the power supply terminal 98a by a screw 102a, and a second end portion of the shape-memory alloy member 100 is connected to the power supply terminal 98b by a screw 102b.

An entire length portion of the shape-memory alloy member 100 is bent in the negative Z-axis direction in an end portion of the top surface of the housing 82, the end portion being located on the negative-X-axis-direction side, and is hooked on the projecting portion 96 after being wound once around the rotary shaft 84 in the counterclockwise direction as seen from the negative Y-axis direction. A center portion of the shape-memory alloy member 100, which is hooked, in a length direction of the shape-memory alloy member 100 forms a substantially inverted U shape in the vicinity of the projecting portion 96.

When power is supplied to the shape-memory alloy member 100 by the power supply terminals 98a and 98b, the shape-memory alloy member 100 contracts by being heated. The rotary shaft 84 is urged by an external force in the forward rotation direction as seen from the negative Y-axis direction. Since the shape-memory alloy member 100 is arranged in the above-described manner, when a thermal contraction force is divided into a first partial thermal contraction force in the forward rotation direction and a second partial thermal contraction force in the Y-axis direction, the first partial thermal contraction force is larger than the second partial thermal contraction force.

Note that, as described above, the contraction amount of the shape-memory alloy member 100 is about 6%, which is small. Considering this, the entire length portion of the shape-memory alloy member 100 is wound once around the rotary shaft 84 so as to obtain a necessary rotation angle. As a result, a large rotation angle can be obtained even though the contraction amount is small. Note that the number of times the entire length portion of the shape-memory alloy member 100 is wound may be more than one, and an increase in the rotation angle may be achieved by reducing the diameter of the rotary shaft.

Referring particularly to FIG. 12, a projecting portion 104 projecting in the radial direction of the rotary shaft 84 is formed on the outer peripheral surface of the rotary shaft 84. A spring post 108 is attached, by screws 110a and 110b, to an end portion of a bottom surface (i.e., a surface that is oriented in the negative Z-axis direction) of the housing 82, the end portion being located on the positive-X-axis-direction side. A first end portion of a bias spring 112 is directly latched to the spring post 108, and a second end portion of the bias spring 112 is latched to the projecting portion 104 via a wire 106. Specifically, the end portions of the wire 106 are connected to the second end portion of the bias spring, and an entire length portion of the wire 106 is hooked on the projecting portion 104 after being wound once around the rotary shaft 84 in the clockwise direction. The bias spring 112 urges the rotary shaft 84 by applying an external force in the reverse rotation direction.

Thus, the cover glass 90 rotates in the reverse rotation direction when the shape-memory alloy member 100 is energized and rotates in the forward rotation direction when energization of the shape-memory alloy member 100 is stopped. Raindrops deposited on the cover glass 90 are caused to move outward by a centrifugal force.

More specifically, before the shape-memory alloy member 100 is energized, lattice deformation occurs in the shape-memory alloy member 100 at the transformation temperature of the shape-memory alloy member 100 or lower, and the shape-memory alloy member 100 is forced to deform and expand by the bias spring 112. Once the shape-memory alloy member 100 has been energized, the shape-memory alloy member 100 generates heat by itself due to Joule heat, and when the temperature of the shape-memory alloy member 100 exceeds the transformation temperature, the shape-memory alloy member 100 returns to its original shape before the lattice deformation occurs. Thermal contraction occurs in the shape-memory alloy member 100, and this causes the cover glass 90 to rotate in the reverse rotation direction while the bias spring 112 is forced to expand.

During the period when the shape-memory alloy member 100 is energized, the resistance of the shape-memory alloy member 100 is monitored. The energization is stopped when the resistance, which has been monitored, falls below a predetermined value. Here, the predetermined value is set from the standpoint of a necessary rotation angle of the cover glass 90, the standpoint of preventing the shape-memory alloy member 100 from being excessively deformed, and the like.

After the energization has been stopped, the shape-memory alloy member 100 is naturally cooled. When the temperature of the shape-memory alloy member 100 falls below the transformation temperature, lattice deformation occurs. The shape-memory alloy member 100 expands, and the cover glass 90 rotates in the forward rotation direction while being pulled by the bias spring 112.

Note that the shape memory alloy member 100 is made of an alloy containing Ni/Ti and the like. The housing 82 is made of a resin such as polyphenylene sulfide (PPS), and the cover glass 90 is made of a transparent resin such as polycarbonate. The bias spring 112 is made of a spring material made of stainless steel or the like, and the power supply terminals 98a and 98b are made of a conductor made of copper, a brass, or the like. The cover-glass rotary gear 86 and the cover-glass mounting gear 88 are made of a metal such as aluminum and a resin such as a polyacetal.

According to the present embodiment, the cover-glass rotary gear 86 is supported by the housing 82 so as to be capable of rotating about the rotary shaft 84 in the forward rotation direction and the reverse rotation direction. The shape-memory alloy member 100 having a wire-like shape urges, by thermally contracting, the rotary shaft 84 by applying an external force in the forward rotation direction. The bias spring 112 urges the rotary shaft 84 by applying an external force in the reverse rotation direction. The cover glass 90 is displaced along with rotation of the rotary shaft 84. Here, the shape-memory alloy member 100 is arranged such that, when the thermal contraction force is divided into the first partial thermal contraction force in the forward rotation direction and the second partial thermal contraction force in a length direction of the rotary shaft 84, the first partial thermal contraction force is larger than the second partial thermal contraction force.

Although a torque generated in the rotary shaft 84 by thermal contraction of the shape-memory alloy member 100 increases as a direction in which the thermal contraction force acts becomes closer to a direction perpendicular to the length direction of the rotary shaft 84, the shape-memory alloy member 100 is arranged such that the first partial thermal contraction force in the forward rotation direction is larger than the second partial thermal contraction force in the length direction of the rotary shaft 84.

As a result, a high torque can be obtained even if the line width of the shape-memory alloy member 100 is small. In addition, by setting the line width of the shape-memory alloy member 100 to be small, the response characteristic of the shape-memory alloy member 100 with respect to energization and the displacement characteristic of the cover glass 90 are improved. As a result, the cover glass 90 can be stably displaced by using a simple structure. In addition, in the present embodiment, it is only necessary to cover the rear camera with the housing 82, and thus, the degree of freedom when designing the housing 82 increases.

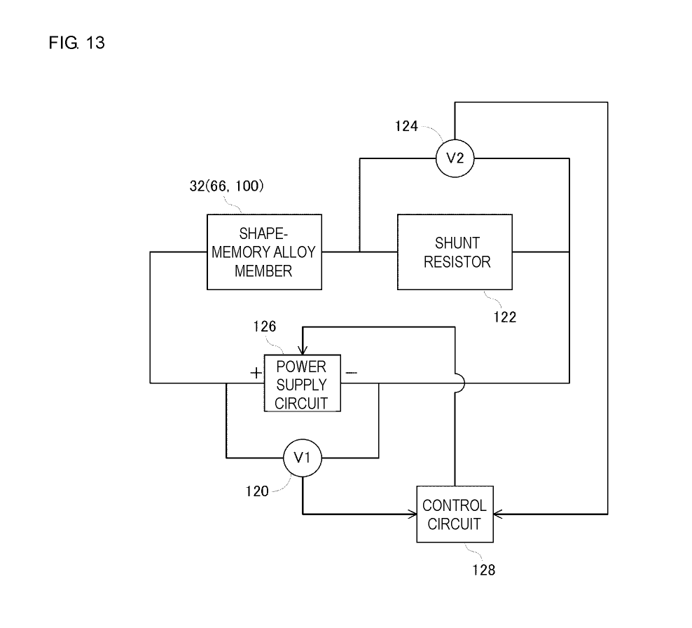

In each of the above-described embodiments, energization of the shape-memory alloy member 32, 66, or 100 is controlled by an energization control device illustrated in FIG. 13. According to FIG. 13, a first end portion of the shape-memory alloy member 32, 66, or 100 is connected to a plus terminal of a power supply circuit 126 that outputs a direct-current voltage. A second end portion of the shape-memory alloy member 32, 66, or 100 is connected to a minus terminal of the power supply circuit 126 via a shunt resistor 112 and a switch circuit 126. The direct-current voltage output by the power supply circuit 126 is measured by a voltmeter 120, and the terminal voltage of the shunt resistor 122 is measured by a voltmeter 124. A control circuit 128 controls the power supply circuit 126 by referencing to outputs of the voltmeters 120 and 124. Note that it is preferable that the resistance of the shunt resistor 122 be equal to or lower than one-tenth of the resistance of the shape-memory alloy member 32, 66, or 100.

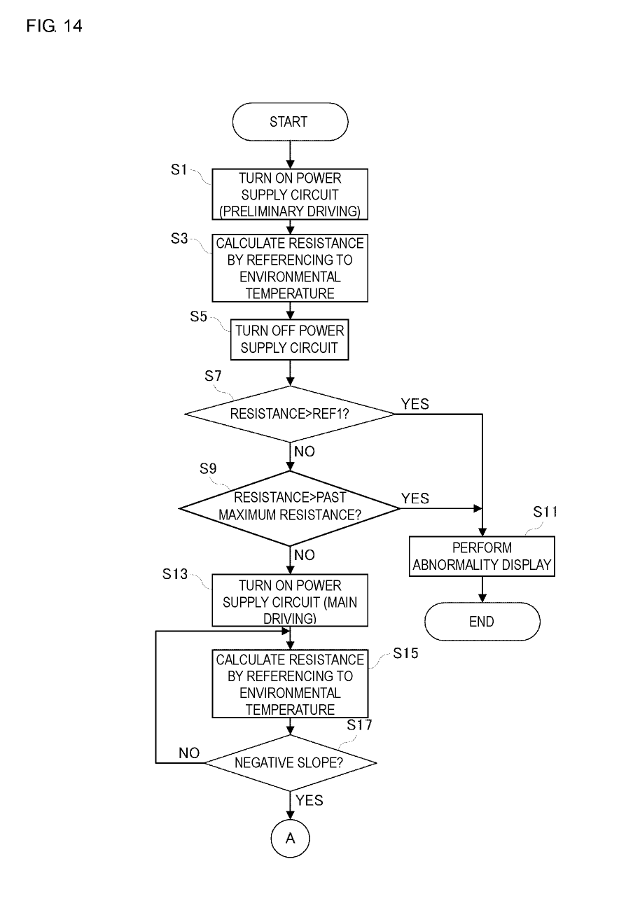

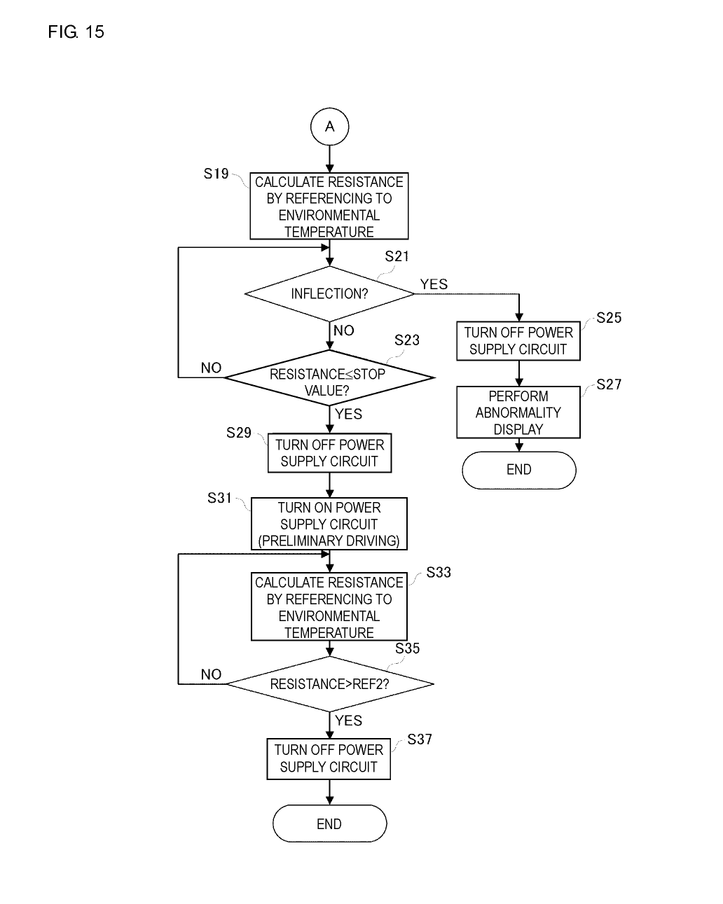

Specifically, the control circuit 128 performs a process according to the flowcharts illustrated in FIG. 14 and FIG. 15. First, in step S1, the power supply circuit 126 is turned on for preliminary driving (for checking the operation of the wiper 18 or 60 or the cover glass 90). In this case, the direct-current voltage output by the power supply circuit 126 is set to be a value that is lower than the transformation temperature of the shape-memory alloy member 32, 66, or 100. In step S3, the resistance of the shape-memory alloy member 32, 66, or 100 is calculated by using a reference resistance at a reference temperature (e.g., 25° C.) on the basis of a terminal voltage measured by the voltmeter 124 and the ambient temperature (environmental temperature) measured by a thermometer (not illustrated). After the resistance has been calculated, the power supply circuit 126 is turned off in step S5.

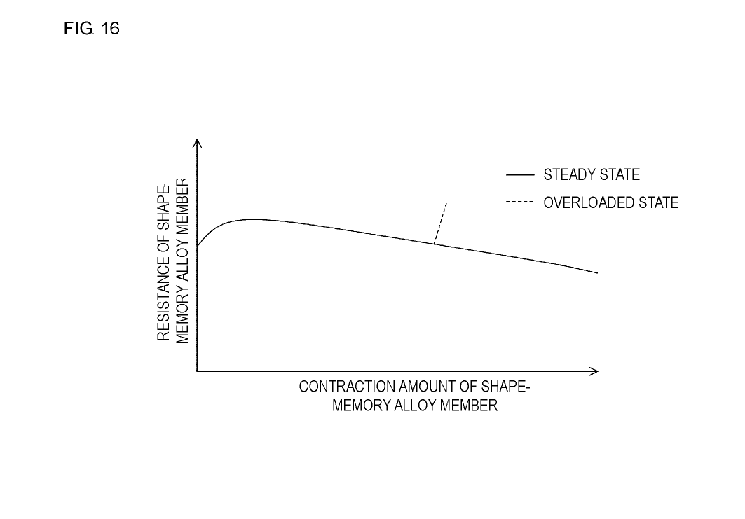

In step S7, it is determined whether the resistance calculated in step S3 is greater than a reference value REF1, and in step S9, it is determined whether the resistance calculated in step S3 is larger than a maximum resistance that has been calculated in the past. The resistance of the shape-memory alloy member 32, 66, or 100 with respect to the contraction amount of the shape-memory alloy member 32, 66, or 100 forms a curved line shown in FIG. 16. Considering this, the reference value REF1 is set to be a value that is sufficiently larger than the maximum resistance that has been calculated in the past. The maximum resistance that has been calculated in the past is stored in a memory (not illustrated).

When the determination result in step S7 or the determination result in step S9 is YES, it is considered that the shape-memory alloy member 32, 66, or 100 is overloaded or it is considered that the shape-memory alloy member 32, 66, or 100 has reached the end of its service life, and the process is terminated after performing an abnormality display in step S11. When both the determination result in step S7 and the determination result in step S9 are NO, the process proceeds to step S13, and the power supply circuit 126 is turned on for main driving. In this case, the direct-current voltage output by the power supply circuit 126 is set to be a value equal to or higher than the transformation temperature of the shape-memory alloy member 32, 66, or 100.

In step S15, the resistance of the shape-memory alloy member 32, 66, or 100 is calculated by using the reference resistance at the reference temperature on the basis of the terminal voltage measured by the voltmeter 124 and the environmental temperature measured by the thermometer. In step S17, it is determined whether the slope of the measured resistance has been changed from a positive slope to a negative slope, and the process of step S15 to step S17 is repeated as long as the determination result is NO.

When the determination result in step S17 is updated from NO to YES, the contraction amount of the shape-memory alloy member 32, 66, or 100 is considered to be larger than a contraction amount corresponding to a maximum resistance shown in FIG. 16, and the process proceeds to step S19. In step S19, the resistance of the shape-memory alloy member 32, 66, or 100 is calculated by using the reference resistance at the reference temperature on the basis of the terminal voltage measured by the voltmeter 124 and the environmental temperature measured by the thermometer.

In step S21, it is determined whether inflection has occurred in variations in the resistance, and in step S23, it is determined whether the resistance has fallen to a stop value. The inflection occurs when the shape-memory alloy member 32, 66, or 100 is overloaded (see FIG. 16). The stop value is set to be a value that is slightly higher than a resistance corresponding to a maximum contraction amount of the shape-memory alloy member 32, 66, or 100.

When the determination result in step S21 is YES, the power supply circuit 126 is turned off in step S25, and the process is terminated after performing an abnormality display in step S27. When both the determination result in step S21 and the determination result in step S23 are NO, the process returns to step S21. When the determination result in step S21 is NO, and the determination result in step S23 is YES, the process proceeds to step S29.

The power supply circuit 126 is turned off in step S29, and in step S31, the power supply circuit 126 is turned on again for preliminary driving (for confirming that the wiper 18 or 60 or the cover glass 90 has returned to its original position and has not been in operation). In step S33, the resistance of the shape-memory alloy member 32, 66, or 100 is calculated by using the reference resistance at the reference temperature on the basis of the terminal voltage measured by the voltmeter 124 and the environmental temperature measured by the thermometer. In step S35, it is determined whether the calculated resistance is larger than a reference value REF2. The reference value REF2 is set to be a value that is slightly lower than a maximum value of the resistance calculated through the process of step S15.

The process of step S33 is repeated as long as the determination result in step S35 is NO. When the determination result in step S35 is updated from NO to YES, it is considered that the contraction amount of the shape-memory alloy member 32, 66, or 100 has been sufficiently decreased, and the process is terminated after turning off the power supply circuit 126 in step S37.

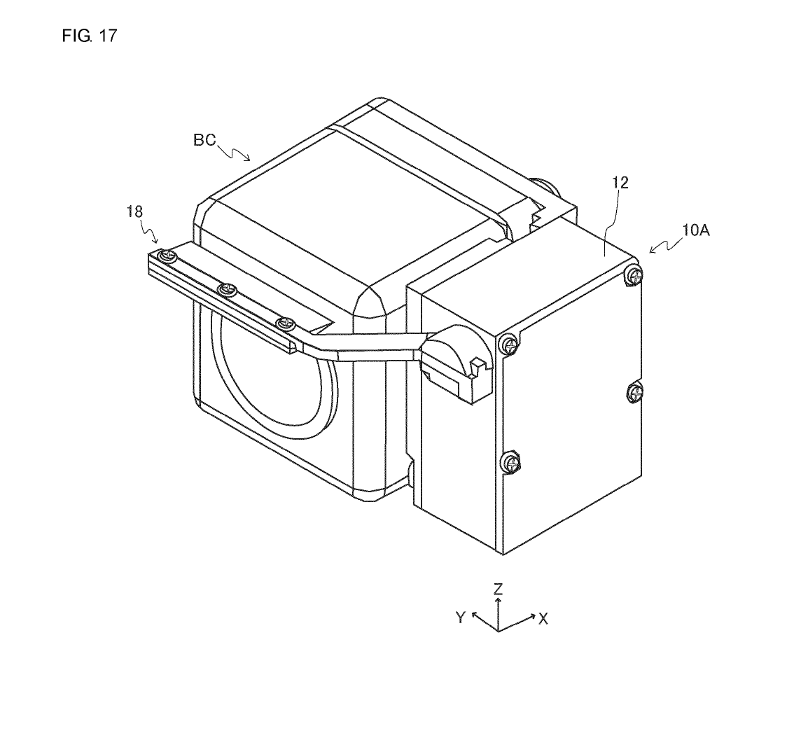

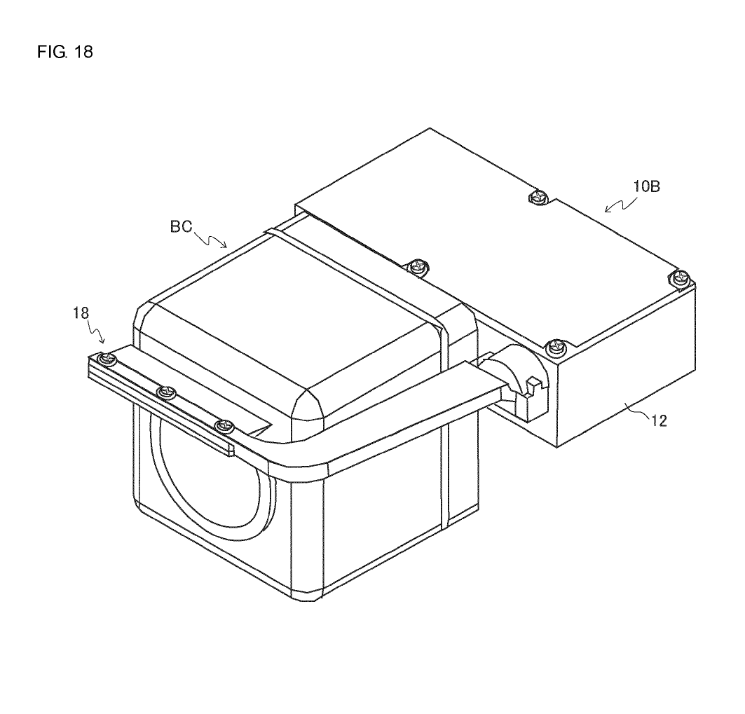

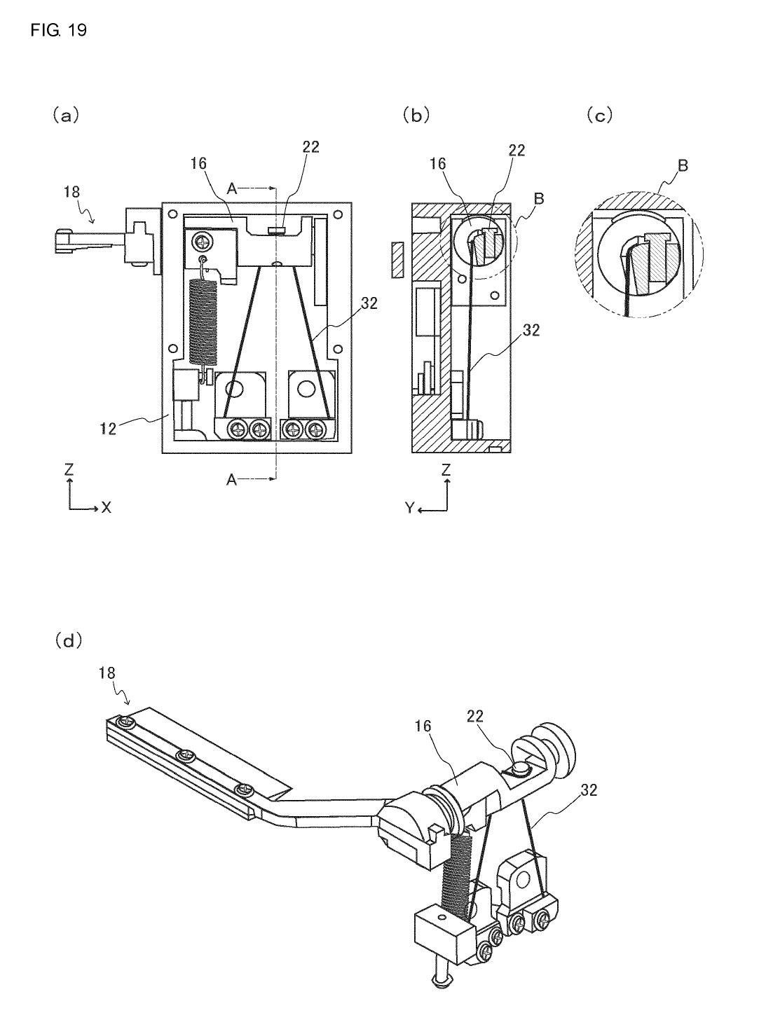

Note that, in the raindrop removal device according to the present invention, the rear camera and the housing of the raindrop removal device may have similar heights. FIG. 17 illustrates an example of a state where a raindrop removal device (10A) is attached to a rear camera, and FIG. 18 illustrates an example of a state where a raindrop removal device (10B) is attached to a rear camera. By reducing the size of the raindrop removal device in this manner, the length of a shape-memory alloy member in a height direction is decreased, and the contraction length of the shape-memory alloy member is decreased. In addition, the rotation angle of a wiper is decreased. FIG. 19 illustrates an example of the raindrop removal device 10A illustrated in FIG. 17. FIG. 19 (a) is a front view of the raindrop removal device 10A. FIG. 19 (b) is a cross-sectional view taken along line A-A of FIG. 19 (a). FIG. 19 (c) is a detailed view of a portion B illustrated in FIG. 19 (b). FIG. 19 (d) is a perspective view of the raindrop removal device 10A in a state where the housing 12 has been removed. As illustrated in FIG. 19, in the rotary shaft 16, if the radius of a region from a position at which the rotary shaft 16 and the shape-memory alloy member 32 are in contact with each other when the rotary shaft 16 is in a non-operating state to a position at which the rotary shaft 16 and the shape-memory alloy member 32 are in contact with each other when rotation of the rotary shaft 16 is ended is set to be small, the rotation angle of the wiper 18 will not be small even if the length of the shape-memory alloy member 32 in the height direction is small. Note that, although when the radius of the entire rotary shaft 16 is small, the strength of the rotary shaft 16 may sometimes be decreased, as illustrated in FIG. 19, deterioration of the strength of the rotary shaft 16 can be suppressed by setting the radius of the region from the position at which the rotary shaft 16 and the shape-memory alloy member 32 are in contact with each other when the rotary shaft 16 is in the non-operating state to the position at which the rotary shaft 16 and the shape-memory alloy member 32 are in contact with each other when rotation of the rotary shaft 16 is ended to be smaller than each of the radiuses of other portions. With this configuration, the size of the raindrop removal device can be reduced.

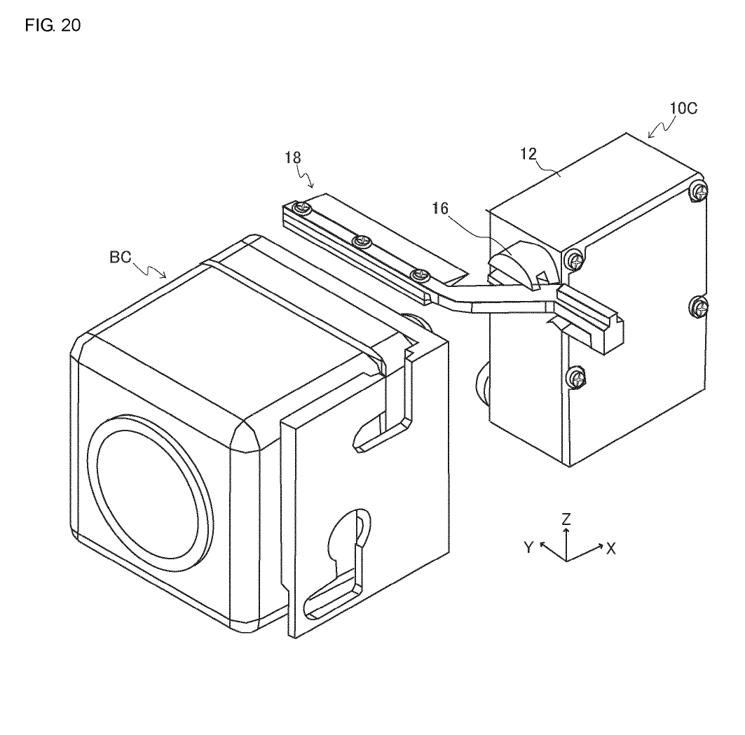

Referring to FIG. 20, as in a raindrop removal device 10C, a structure in which the wiper 18 is fitted to the rotary shaft 16 may be employed so that the wiper 18 is removable from the rotary shaft 16. With this structure, when the wiper 18 has been worn away, the wiper 18 can be easily replaced.

### REFERENCE SIGNS LIST

10, 50, 80 raindrop removal device (driving device)
16, 84 rotary shaft (rotary member)
18, 60 wiper (object)
30 rotation stopper (restricting member)
32, 66, 100 shape-memory alloy member
46, 74, 112 bias spring
58a, 58b screw
90 cover glass
34a, 34b, 64a, 64b, 98a, 98b power supply terminal
22, 62, 96 projecting portion (latch portion)
122, 124 voltmeter (measuring device)
128 control circuit (control device)

1. A driving device comprising:
a rotary member supported in a housing of the driving device and configured to rotate in first and second directions opposite to each other around a reference axis;
a shape-memory alloy member coupled to the rotary member and having a wire-like shape, wherein the shape-memory alloy member thermally contracts when heated urging the rotary member to rotate in the first direction;
a biasing member coupled to the rotary member that urges the rotary member to rotate in the second direction; and
an object coupled to the rotary member that is displaced when the rotary member rotates in the first direction and the second direction.

2. The driving device according to claim 1, wherein the shape-memory alloy member is configured such that, when a thermal contraction force is divided into a first partial thermal contraction force in a direction orthogonal to a length direction of the reference axis and a second partial thermal contraction force in the length direction of the reference axis, the first partial thermal contraction force is larger than the second partial thermal contraction force.

3. The driving device according to claim 1, further comprising a restricting member affixed to the housing that restricts rotation of the rotary member in the second direction such that an upper limit of a rotation angle of the rotary member is an angle corresponding to a maximum deformation amount of the shape-memory alloy member.

4. The driving device according to claim 1, further comprising a supply source that supplies power to the shape-memory alloy member.

5. The driving device according to claim 4, wherein the supply source includes two power supply terminals respectively coupled to ends of the shape-memory alloy member, and the two power supply terminals heat the shape-memory alloy member causing the shape-memory alloy member to thermally contract.

6. The driving device according to claim 5, wherein the rotary member includes a projecting member to which the shape-memory alloy member is coupled at a position different from the ends of the shape-memory alloy member.

7. The driving device according to claim 6,
wherein the rotary member includes a shaft that extends in the direction of the reference axis and that has a diameter that varies along a length of the rotary member, and
wherein the projecting member projects in a radial direction of the rotary shaft from an outer peripheral surface of the rotary shaft at a position at which the diameter of the rotary shaft is not a maximum diameter of the rotary shaft.

8. The driving device according to claim 4, further comprising:
a measuring device that measures a resistance of the shape-memory alloy member; and
a control device configured to control energization of the shape-memory alloy member based on a resistance measured by the measuring device.

9. The driving device according to claim 8, wherein the control device is further configured to control the energization of the shape-memory alloy member by detecting an inflection point that appears in the resistance when the shape-memory alloy member is overloaded.

10. The driving device according to claim 8, wherein the control device is further configured to perform a pre-operation check in a preliminary driving mode at a temperature lower than a transformation temperature of the shape-memory alloy member.

11. The driving device according to claim 10, wherein the control device is configured to confirm that the object is not in operation in the preliminary driving mode at the temperature lower than the transformation temperature of the shape-memory alloy member.

12. The driving device according to claim 1, wherein the object comprises a wiper that rotates in the first direction and the second direction to remove raindrops.

13. The driving device according to claim 1, further comprising a changing portion that changes an extending direction of the wire member formed of the shape-memory alloy member at a position spaced apart from the rotary member.

14. The driving device according to claim 1, wherein the biasing member is a coil with a first end coupled to the rotary member and a second end coupled to a base portion of the housing.

15. The driving device according to claim 1, wherein the rotary member extends through a hole of the housing and the object is coupled to an end of the rotary member that is outside the housing of the driving device.

16. (canceled)

17. The driving device according to claim 22, wherein the object is a cover glass that is held by the cover-glass mounting gear.

18. A driving device comprising:
a housing;
at least one arm rotatably coupled to the housing;
a shape-memory alloy member coupled to the at least one arm and having a wire-like shape, wherein the shape-memory alloy member thermally contracts when heated urging the at least one arm to move in a first direction;
a biasing member coupled to the at least one arm that urges the at least one arm to move in a second direction that is opposite the first direction; and
an object coupled to the at least one arm that is displaced when the at least one arm moves in the first direction and the second direction.

19. The driving device according to claim 18, wherein the shape-memory alloy member is configured such that, when a thermal contraction force is divided into a first partial thermal contraction force in a first direction orthogonal to an axis of rotation of the at least one arm about the housing and a second partial thermal contraction force in a second direction perpendicular to the first direction, the first partial thermal contraction force is larger than the second partial thermal contraction force.

20. The driving device according to claim 18,
wherein the at least one arm comprises a pair of arms rotatably coupled to the housing, with the shape-memory alloy member coupled to at least one of the pair of arms, and
wherein the object is a wiper blade that extends between respective ends of the pair of arms.

21. The driving device according to claim 1, wherein the housing of the driving device is L-shaped and the shape-memory alloy member extends in both arms of the L-shaped housing with a stationary guide directing the shape-memory alloy member about the two arms of the L-shaped housing.

22. The driving device according to claim 1, further comprising:
a cover-glass rotary gear coupled to the rotary member and having a plurality of teeth; and
a cover-glass mounting gear having a plurality of teeth mechanically coupled to the plurality of teeth cover-glass rotary gear, such that the cover-glass rotary gear drives the cover-glass mounting gear to rotate in the second direction when the shape-memory alloy member urges the cover-glass rotary gear to rotate in the first direction upon thermal contraction of the shape-memory alloy member.
